(19) United States
(12) Patent Application Publication
(10) Pub. No.: US 2022/0205107 A1
(43) Pub. Date: Jun. 30, 2022

(54) SYSTEMS, METHODS, AND APPARATUS FOR PRELITHIATION THROUGH LIQUID ALKALI METAL COMPOSITION SPRAY APPLICATION

(71) Applicant: Storagenergy Technologies Inc., Salt Lake City, UT (US)

(72) Inventors: Junhua Song, South Jordan, UT (US); Feng Zhao, Salt Lake City, UT (US); Jinyun Liao, Herriman, UT (US)

(73) Assignee: Storagenergy Technologies Inc., Salt Lake City, UT (US)

(21) Appl. No.: 17/565,931

(22) Filed: Dec. 30, 2021

Related U.S. Application Data
(60) Provisional application No. 63/132,638, filed on Dec. 31, 2020.

(51) Int. Cl. C23C 22/02; C23C 22/76

(52) U.S. Cl. CPC C23C 22/02; C23C 22/76

(57) ABSTRACT

Systems and methods for the treatment of materials with an alkali metal such as lithium for the manufacturing of batteries and capacitors. In one illustrative embodiment, a liquid lithium composition may be formed by dissolving metallic lithium in a solution that includes a suitable organic agent, a suitable solvent and suitable film forming agent. Each component of the solution may be present in an effective amount to perform its desired function. The lithium may be dissolved into the solution to obtain a lithium to organic agent molar ratio of from 1:1 to 10:1. The liquid lithium composition may then be dispensed onto a suitable substrate material and allowed to remain thereon for a suitable time for a prelithiation reaction to proceed, followed by drying. Dispensing may be performed by spraying the liquid lithium composition and drying may be performed at a relatively low temperature and a reduced pressure.

### CROSS-REFERENCE TO RELATED APPLICATION

This application claims the benefit of U.S. Provisional Application No. 63/132,638, filed Dec. 31, 2020, the contents of which are incorporated herein by reference in its entirety, including but not limited to those portions that specifically appear hereinafter.

### TECHNICAL FIELD

This disclosure relates to systems, methods, and apparatus for the pretreatment of materials, especially silicon materials, with alkali metal solution for the manufacturing of batteries and capacitors, such a prelithiation.

### BACKGROUND

Current prelithiation methods, such as stabilized lithium metal powder, physical vapor lithium deposition and lithium metal sheet based electrochemical prelithiation are relatively expensive and/or difficult to implement in a compatible manner with existing electrode manufacturing lines. One attempt to provide an improved process was set forth in the article by Jang et al., Molecularly tailored lithium arene complex enables chemical prelithiation of high-capacity lithium-ion battery anodes, Angew. Chem. Int. Ed. 2020, 132, 14581-14588, doi: 10.1002/anie.202002411, the contents of which are incorporated by reference herein in its entirety, which uses immersion of an anode material in a lithium-arene complex solution to perform an uncontrolled lithiation step, followed by a rinsing bath and a high heat drying. However, due to the lack of control and the additional required high energy input step, such proposed process may be problematic or expensive to implement.

A method for pretreatment with an alkali metal, such as prelithiation, that was more efficient, lower in cost, and/or more compatible with existing electrode manufacturing line for high power and high energy batteries and capacitors would be an improvement in the art. Such methods, systems and processes that achieved fast and effective lithium compensation during electrode fabrication and before cell assembly would allow for the development of high energy density cells using lithium deficient electrode materials and thus be a further improvement in the art.

### SUMMARY

The present disclosure is directed to systems and methods for the pretreatment of materials with an alkali metal solution for the manufacturing of batteries and capacitors. Realizing high energy density and long-term cycling stability of rechargeable batteries and capacitors requires embodied pretreatment methods through that allows alkali metal intercalation/alloying/conversion reaction with positive and negative electrodes, forms stable electrode/electrolyte interphase, mitigates alkali metal loss, increases cell energy density and adapts to any existing electrode manufacturing process. Processes in accordance with the present disclosure address these challenges directly with a liquid alkali metal composition and a corresponding pretreatment procedure for high energy density alkaline-ion batteries and capacitors. In one illustrative embodiment, the alkali metal may be lithium, and the processes generally referred to herein as prelithiation. It will be appreciated that other alkali metals, including sodium and potassium may be used for particular applications. Such processes may utilize reactants that can be oxidized and react with a variety of anode and cathode materials by forming lithiated compound through ion intercalation, alloying and conversion reactions. The reactants may be developed by converting metallic lithium into a liquid solution comprised of lithium ion and coordinating solvent molecules, a film forming agent, and negatively charged organic compounds, which have lower redox potential than the electrode materials. The liquid lithium composition begins lithiation reaction instantly when in contact with target materials and can achieve desired lithiation state in as little time as 5 minutes. Depending on the solvent molecules, film forming agent, and organic species present in the liquid lithium, the decomposition products on the electrode materials forms a low resistance and highly ion conductive interphase, which promotes the battery's cycle life and shortens the time needed for cell formation.

Prelithiation compensates the permanent capacity loss caused by irreversible phase transition and solid-electrolyte-interphase formation of electrode materials, which traps active lithium ion during the initial charge-discharge cycles and thus leads to low Coulombic efficiency. Liquid lithium-based prelithiation method provides at minimum 20% improvement in terms of first cycle Coulombic efficiency for lithium-accepting materials. At least 15% increment of specific energy can be achieved in full cell configuration comprised of lithium-accepting anode and lithium-providing cathode. In some embodiments, treatment of a single electrode material can be used to compensate for both the anode and the cathode in battery cell. The present disclosure also addresses the manufacturing process for both liquid lithium compositions and prelithiation procedures. Large volumes of liquid lithium solution can be prepared under room temperature in a short time and is readily scaled up with larger container size. Prelithiation process involves evenly dispensing liquid lithium containing solution over an electrode substrate and a subsequent drying step. The liquid dispensing system may be accomplished by an add-on equipment to the typical roll-to-roll electrode manufacturing lines between the slot die-casting and electrode drying steps or after electrode calendaring. The lithiation degree may be controlled by the flow rate of the liquid lithium and feeding speed of the electrode sheet.

In one illustrative embodiment, a liquid alkali metal composition, such as a liquid lithium composition, may be formed by dissolving the metallic alkali metal in a solution that includes a suitable organic agent, a suitable solvent and suitable film forming agent. The solvent functions to dissolve the remaining components, the organic agent functions to coordinate the metallic alkali metal and the film forming agent functions to form an ion conductive interphase film following application. Each component of the solution may be present in an effective amount to perform the desired function. Where the alkali metal is lithium, the metallic lithium may be dissolved into the solution to obtain a lithium to organic agent molar ratio of from 1:1 to 10:1 in the liquid lithium composition.

The liquid alkali metal composition may be dispensed onto a suitable substrate material such as a silicon, carbon or composite anode material and allowed to remain thereon for a suitable time for the pretreatment reaction to proceed, followed by the drying of the pretreated substrate. The pretreatment of the substrate with alkali metal (or alkali metallization of the substrate) may take place simultaneously with the formation of the ion conductive interphase film. Dispensing may be performed by spraying on the substrate surface. Drying may be performed at a relatively low temperature and at a reduced pressure. The resulting pretreated substrate may serve as an anode material for a rechargeable battery or capacitor and the method may be compatible with existing electrode manufacturing line equipment or techniques.

### DESCRIPTION OF THE DRAWINGS

It will be appreciated by those of ordinary skill in the art that the various drawings are for illustrative purposes only. The nature of the present disclosure, as well as other embodiments in accordance with this disclosure, may be more clearly understood by reference to the following detailed description, to the appended claims, and to the several drawings.

FIG. 1A is a process diagram providing an overview of an illustrative prelithiation process in accordance with the principles of the present disclosure.

FIG. 1B is a process diagram providing an overview of an illustrative prelithiation process in accordance with the principles of the present disclosure conducted as part of a roll-to-roll electrode manufacturing line.

FIG. 2 is a chart depicting a comparison of the initial cycle Coulombic efficiency of a hard carbon anode treated with a process in accordance with the present disclosure to an untreated hard carbon anode.

FIG. 3 is a chart depicting a comparison of the initial cycle Coulombic efficiency of a hard carbon/silicon composite anode treated with a process in accordance with the present disclosure to an untreated hard carbon/silicon anode.

FIG. 4 is a chart depicting a comparison of the initial cycle Coulombic efficiency of a Gr-Si composite anode treated with a process in accordance with the present disclosure to an untreated Gr-Si anode, in Li∥Gr-Si half cells.

FIG. 5 is a chart depicting a comparison of the initial cycle Coulombic efficiency of a Gr-Si composite anode treated with a process in accordance with the present disclosure to an untreated Gr-Si anode, in Gr-Si∥NMC811 full cells.

FIG. 6 is a chart depicting a comparison of the cycling stability of a Gr-Si composite anode treated with a process in accordance with the present disclosure to an untreated Gr-Si anode, in Gr-Si∥NMC811 full cells.

FIG. 7 is a chart depicting a comparison of the rate capability of a Gr-Si composite anode treated with a process in accordance with the present disclosure to an untreated Gr-Si anode, in Gr-Si∥NMC811 full cells.

### DETAILED DESCRIPTION

The present disclosure relates to apparatus, systems, and methods for the pretreatment of materials with alkali metals for the manufacturing of batteries and capacitors. It will be appreciated by those skilled in the art that the embodiments herein described, while illustrative, are not intended to so limit this disclosure or the scope of the appended claims. Those skilled in the art will also understand that various combinations or modifications of the embodiments presented herein can be made without departing from the scope of this disclosure. All such alternate embodiments are within the scope of the present disclosure.

In one illustrative embodiment, a liquid composition of alkali metal, such as lithium, may be formed by dissolving a metallic alkali metal in a solution that includes a suitable organic agent, a suitable solvent and suitable film forming agent. With respect the organic agent where metallic lithium is used, this compound functions to coordinate with the metallic lithium, allowing it to be dissolved into the solution. Some exemplary organic agents may include: Naphthalene, biphenyl, 3,3′-dimethylbiphenyle, 4,4′-dimethyl biphenyl, 2-methylbiphenyl, 3,3,4,4′-tetramethylbiphenyl, and 9,9-dimethyl-9H-fluorene. It will be appreciated that one or more organic agents may be used in a solution and that other organic agents than those listed may be used, so long as the selected organic agent(s) fulfill the function of coordinating with Li ion dissolved into a solution in a form allowing it to be deposited on a suitable substrate in accordance with processes complying with the principles of the present disclosure. It will be further appreciated that where other alkali metals are used, other organic agents may be used.

Some exemplary solvents for the liquid lithium containing composition may include: 1,2-dimethoxyethane, tetrahydrofuran, chloroform, acetonitrile, tetraethylene glycol dimethyl ether dimethylformamide, triethylene glycol dimethyl ether, dimethoxyethane, 2-methyl-tetrahydrofuran, and Methyltetrahydrofuran. It will be appreciated that one or more solvents may be used in the liquid lithium containing solutions and that additional solvents other than those listed may be used, so long as the selected solvents fulfill the function of dissolving the remaining components in solution in a form allowing the prelithiation processes complying with the principles of the present disclosure to be performed. It will be further appreciated that where other alkali metals are used, other solvents may be used.

Some exemplary film forming agents for the liquid lithium containing composition may include: fluoroethylene carbonate, vinylene carbonate, 1,1,2,2-tetrafluoroethyl-2,2,3,3-tetrafluoroproppyl ether, bis(2,2,2-trifluoroethyl) ether, 1,1,2,2-tetrafluoroethyl-2,2,2-trifluoroethyl ether, methoxynonafluorobutane, ethoxynonafluorobutane, tris(2,2,2-trifluoroethyl)orthoformate, pentafluoroethyl 2,2,2-trifluoroethyl ether, 2,2,3,3,4,4,5,5-ocatafluoro-1-pentanol, and 2,2,2-trifluoroethyl nonafluorobutanessulfonate. It will be appreciated that one or more film forming agents may be used in the liquid lithium containing solutions and that additional film-forming agents other than those listed, so long as the selected film forming agents fulfill the function of initiating polymerization to form an ion conductive interphase film on the substrate surface in a process in accordance with the present disclosure. It will be further appreciated that where other alkali metals are used, other film forming agents may be used.

As noted above, in lithium containing solutions in accordance with the present disclosure, the solvent functions to keep the remaining components in solution, the organic agent functions to dissolve the metallic lithium into the solution and the film forming agent functions to form an ion conductive interphase film following application. Each component of the solution may be present in an effective amount to perform the desired function. In a typical solution: (1) the organic agent's concentration in solvent can range from 0.1M to 4M; (2) the film forming additive weight fraction can range from 0-5 wt. %; and (3) the lithium source: organic agent molar ratio can range from 1:1 to 10:1.

In processes in accordance with the present disclosure, the liquid lithium containing composition may be formed by preparing a process solution of the selected solvent, organic agent and film forming agent and then dissolving metallic lithium into the process solution. The mixing of solution and addition of lithium may be carried out a suitable temperature and pressure, for example at a temperature of from about 25° C. to about 50° C. may be suitable for integration into current processes. The liquid lithium containing composition may be maintained by stirring until dispensed. The liquid lithium containing composition may be formed and maintained under an inert gas atmosphere until used.

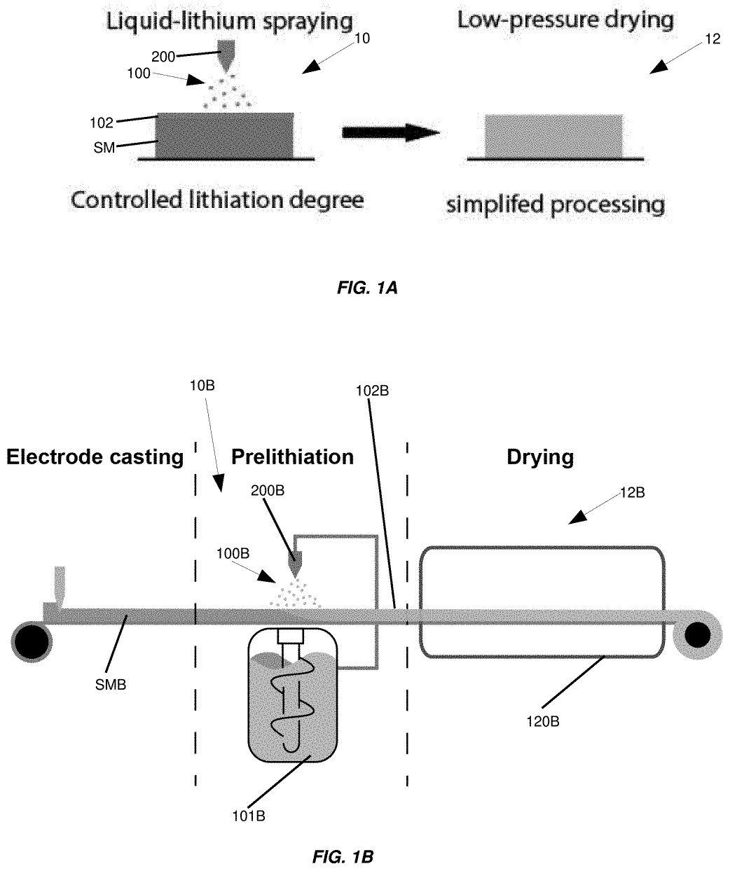

As depicted in FIG. 1A, at step 10, the liquid lithium composition 100 may be dispensed onto a suitable substrate material SM such as a silicon, carbon or composite anode material and allowed to remain thereon for a suitable time for a prelithiation reaction to proceed as by forming a film 102, followed by the drying of the prelithiated substrate in a subsequent drying step 12. Dispensing may be performed in any suitable manner including direct dispensing, spraying on the substrate surface with a spray gun 200, or as otherwise readily adaptable to current substrate processing procedures for battery or capacitor manufacturing.

Some suitable substrate materials on which the pretreatment, including prelithiation, may be performed may include: silicon, tin, antimony, hard carbon, silicon-graphite phosphorus, aluminum, germanium, sulfur, iron fluoride, iron sulfide, copper fluoride, and AₓMO₂ (0<X<1, A=alkaline metals and M=transition metals), among others. It will be appreciated that a suitable substrate material may include silicon-based substrates that contain silicon with other materials, including graphite, tin, antimony, hard carbon, phosphorus, aluminum, germanium, sulfur, iron fluoride, iron sulfide, copper fluoride, and AₓMO₂ (0<X<1, A=alkali metals and M=transition metals). In some embodiments, such substrates may contain from 0.1% to 100% silicon and may include graphite-silicon substrates.

The molar ratio of the liquid lithium and substrate material may be from about: 1:1 to about 10:1. The prelithiation reaction may be conducted at a temperature of from about 0° C. to about 100° C. and the reaction may proceed from about 5 minutes to about 1 hour. Upon dispensing onto the substrate, the film forming agent may initiate a polymerization reaction to form an ion conductive interphase layer on the substrate form the liquid lithium containing composition as the prelithiation reaction proceeds.

Drying may be performed at a relatively low temperature and at a reduced pressure. For example, a drying temperature of from about 50° C. to about 120° C. and a vacuum level of from about 500 mbar to about 1000 mbar.

The resulting pretreated substrate may serve as an anode material for a rechargeable battery or capacitor and the method may be compatible with existing electrode manufacturing line equipment or techniques, as depicted in FIG. 1B.

As depicted in FIG. 1B, a suitable substrate material SMB, such as a silicon, carbon, or composite anode material, as it advances and is processed on a roll-to-roll electrode manufacturing line. At step 10B, the liquid lithium composition 100B may be dispensed onto a portion of the substrate. As depicted, the dispensing may be performed using a suitable spray head 200B, which is in fluid communication with a reservoir 101B liquid lithium composition.

As the substrate advances, the liquid lithium composition 100B is allowed to remain thereon for a suitable time for a prelithiation reaction to proceed as by forming a film 102B. This may then be followed by the drying of the prelithiated substrate in a subsequent drying step 12B, which may take place in suitable drying chamber 120 for maintaining a suitable temperature and pressure as the substrate SMB is advanced therethrough.

It will be appreciated that in methods in accordance with the present disclosure, the liquid lithium solution dispensing may be performed by spray coating, direct dispensing, or a liquid feeding system. Suitable mixing systems, drying systems, may be used allowing for an integration to roll-to-roll processing for preparation of anode and cathode materials.

### EXPERIMENTAL EXAMPLES

### Example 1

Preparation of Liquid Lithium Containing Composition

Step 1: Solution 1 was formed by preparing 1 M 4,4′-dimethyl biphenyl (organic agent) in 1,2-dimethoxyethane (solvent) and then adding 2 weight percent of fluoroethylene carbonate (film forming agent).

Step 2: Metallic lithium (lithium source) was dissolved into Solution 1 under magnetic stirring for 2 hours at 25° C. The obtained liquid lithium containing solution had a molar ratio of lithium:organic agent of 2:1.

### Example 2: Hard Carbon Electrode

A liquid lithium containing composition was prepared as in Example 1 and a hard carbon electrode was prepared using the following protocol:

Step 1: A slurry composed of HC, carbon black and binder (polyvinylidene fluoride) with a mass ratio of 8:1:1 was mixed using a planetary centrifugal mixer. Step 2: The slurry was casted on a Cu foil current collector via dr. blade. Step 3: The electrode was baked at 90° C. for 1 hr and then roll-pressed before overnight drying at 120° C. The mass loading of the HC was controlled at ˜3 mg cm⁻².

The prepared hard carbon electrode was treated with the liquid lithium containing composition in the same manner as the electrode of Example 1. Pristine and prelithiated electrode was then electrochemically tested in the same manner as Example 1.

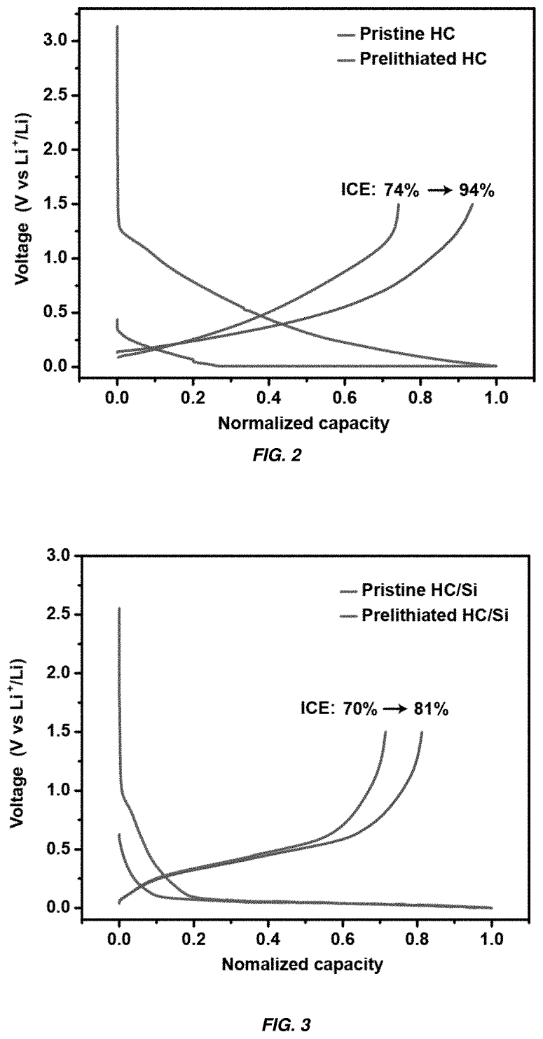

FIG. 2 is a chart depicting a comparison of the initial cycle Coulombic efficiency of the threated hard carbon anode compared to the untreated hard carbon anode. As depicted, the hard carbon anode material treated using the liquid lithium containing solution and protocol of the present disclosure has an improvement of about 20%.

### Example 3: Hard Carbon/Silicon Electrode

A liquid lithium containing composition was prepared as in Example 1 and hard carbon/silicon electrode was prepared using the following protocol:

Step 1: A slurry composed of HC, silicon, carbon black and binder (polyvinylidene fluoride) with a mass ratio of 5:3:1:1 was mixed using a planetary centrifugal mixer. Step 2: The slurry was casted on a Cu foil current collector via dr. blade. Step 3: The electrode was baked at 90° C. for 1 hr. and then roll-pressed before overnight drying at 120° C. The mass loading of the HC/Si was controlled at ˜3 mg cm⁻².

The prepared hard carbon/silicon electrode was treated with the liquid lithium containing composition in the same manner as the electrode of Example 1. Pristine and prelithiated electrode was then electrochemically tested in the same manner as Example 1.

FIG. 3 is a chart depicting a comparison of the initial cycle Coulombic efficiency of an untreated hard carbon/silicon composite electrode compared to the hard carbon/silicon composite electrode material treated using the liquid lithium containing solution and protocol of the present disclosure, which shows an improvement of about 11%.

### Example 4

Electrode Preparation

Cathode preparation: a slurry composed of lithium nickel manganese oxide powder (NMC), conductive carbon and binder (polyvinylidene fluoride) with a mass ratio of 9.4:0.3:0.3 was mixed using a planetary centrifugal mixer. (2) The slurry was casted on an Al foil current collector via Dr. blade. (3) The electrode was baked at 90° C. for 1 hr and then roll-pressed before overnight drying at 120° C.

Anode preparation: a slurry composed of graphite-silicon (Gr-Si), conductive carbon and binder (polyvinylidene fluoride) with a mass ratio of 9.4:0.3:0.3 was mixed using a planetary centrifugal mixer. (2) The slurry was casted on a Cu foil current collector via Dr. blade. (3) The electrode was baked at 90° C. for 1 hr and then roll-pressed before overnight drying at 120° C.

Preparation of Liquid Lithium Containing Composition

Step 1: Precursor solution was formed by preparing 1 M 4,4′-dimethyl biphenyl (organic agent) in in 2-methyl-tetrahydrofuran (solvent) and then adding 2 weight percent of fluoroethylene carbonate (film forming agent).

Step 2: Metallic lithium (lithium source) was dissolved into the precursor solution under magnetic stirring for 2 hours at 25° C. The obtained liquid lithium containing solution had a molar ratio of lithium:organic agent of 2:1.

Prelithiation of Graphite-Silicon (Gr-Si) Anode and Manufacturing

The prepared liquid lithium containing solution was dispensed onto the Gr-Si electrode in Ar-filled glove box at room temperature. The formulation of the Gr-Si anode was Si (target material)/binder/carbon additive (mass ratio of 94:3:3). The molar ratio between the dispensed liquid lithium and Gr-Si was 2:1. The direct dispensing was performed by pipetting. The prelithiation reaction was allowed to proceed for 5 minutes, 10 minutes or 30 minutes, followed by vacuum drying at 100° C. for 20 minutes.

Electrochemical Testing

(1) The electrode (pristine or prelithiated) was cut into a 1.76 cm² laminate.

(2) 2032 coin cells were assembled in an argon-filled glove box using a polyethylene (PE) separator, a Gr-Si anode (treated or untreated) and a cathode.

(3) The cells were rested in an Arbin cycler at 25° C. for 6 hr before electrochemical testing.

(4) Cycling test was carried out with 3 formation cycles at 0.1 C (1 C equals to fully discharge/charge the battery in 1 hour) and continuous cycling at 1 C between 2.5-4.15 V.

(5) Rate testing was carried out at current densities of 0 C/20, C/10, C/5, C/2, 1 C and 2 C between 2.5-4.15 V.

Results

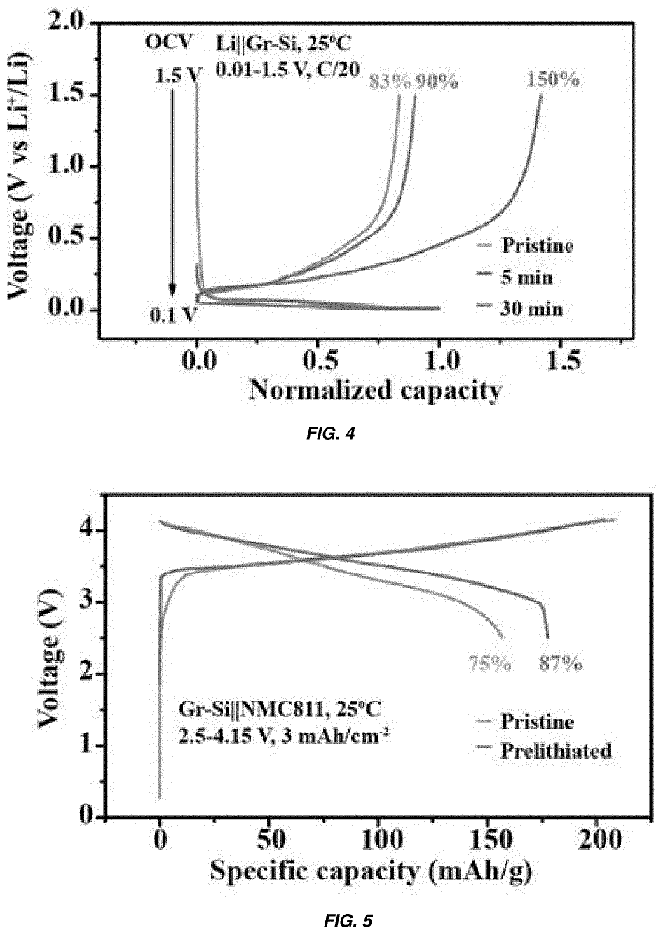

FIG. 4 is a chart depicting a comparison of the initial cycle Coulombic efficiency of a Gr-Si composite anode treated with a process in accordance with the present disclosure to an untreated Gr-Si anode, in Li∥Gr-Si half cells. As depicted, half cells using anode had undergone a 5-minute prelithiation reaction showed a 7% improvement (from 83% to 90%) in normalized capacity and half cells using anode that had undergone a 30-minute treatment showed a 73% improvement (from 83% to 150%) in normalized capacity.

FIG. 5 is a chart depicting a comparison of the initial cycle Coulombic efficiency of a Gr-Si composite anode treated with a process in accordance with the present disclosure to an untreated Gr-Si anode, in Gr-Si∥NMC8111 full cells. As depicted, full cells using anode had undergone a 10-minute prelithiation reaction showed a 12% improvement (from 75% to 87%) in specific capacity.

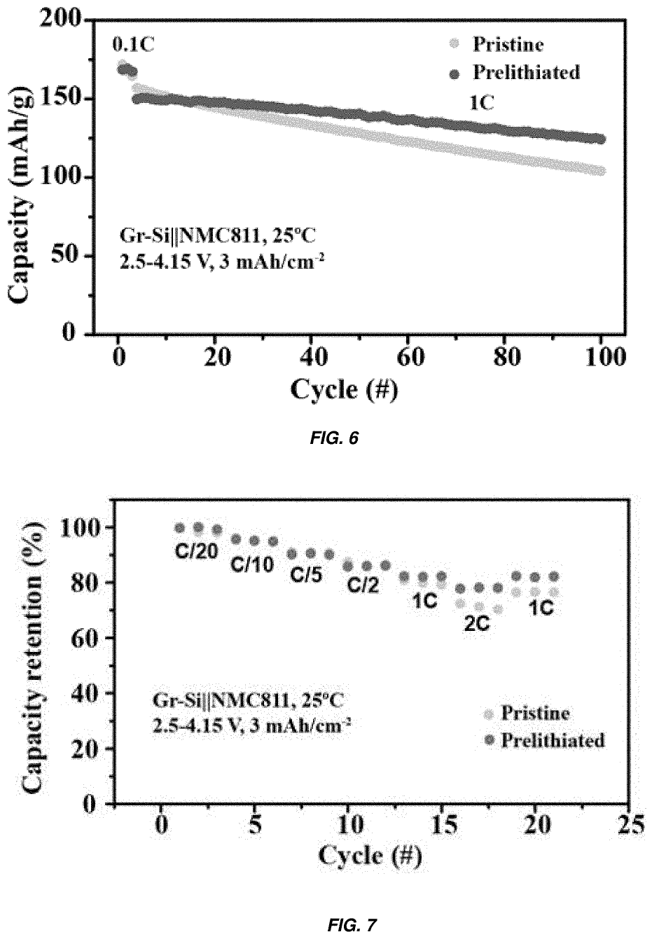

FIG. 6 is a chart depicting a comparison of the cycling stability of a Gr-Si composite anode treated with a process in accordance with the present disclosure to an untreated Gr-Si anode, in Gr-Si∥NMC8111 full cells. As depicted, full cells using anode had undergone a 10-minute prelithiation reaction showed a 20% improvement in capacity retention over 100 cycles.

FIG. 7 is a chart depicting a comparison of the rate capability of a Gr-Si composite anode treated with a process in accordance with the present disclosure to an untreated Gr-Si anode, in Gr-Si∥NMC8111 full cells. As depicted, full cells using anode had undergone a 10-minute prelithiation reaction showed a 5% improvement in capacity utilization at 2 C discharge rate.

While this disclosure has been described using certain embodiments, it can be further modified while keeping within its spirit and scope. This application is therefore intended to cover any variations, uses, or adaptations of the disclosure using its general principles. This application is intended to cover any and all such departures from the present disclosure as come within known or customary practices in the art to which it pertains, and which fall within the limits of the appended claims.

What is claimed is:

1. A process for pretreating a silicon substrate with an alkali metal solution, the process comprising:
dispensing a liquid alkali metal containing composition on a silicon substrate, the liquid alkali metal containing composition comprising
a suitable organic agent,
a suitable solvent,
a suitable film forming agent, and
a dissolved alkali metal;
performing a pre-alkali metal treatment reaction by initiating an alloying reaction between the silicon substrate and the dissolved alkali metal; and
forming an ion conductive interphase film on the silicon substrate surface; and
drying the treated silicon substrate.

2. The process of claim 1, further comprising forming the liquid alkali metal composition by
creating a precursor solution comprising the suitable organic agent, the suitable solvent, and the suitable film forming agent; and
dissolving a metallic alkali metal into the precursor solution.

3. The process of claim 2, wherein dissolving a metallic alkali metal comprises dissolving metallic lithium to form a liquid lithium composition and the pre-alkali metal treatment reaction comprises prelithiation.

4. The process of claim 3, wherein dissolving metallic lithium in a solution that includes a suitable organic agent, a suitable solvent and a suitable film forming agent comprises forming a solution for dissolving metallic lithium including one or more organic agents selected from the following: naphthalene, biphenyl, 3,3′-dimethylbiphenyle, 4,4′-dimethyl biphenyl, 2-methylbiphenyl, 3,3,4,4′-tetramethylbiphenyl, and 9,9-dimethyl-9H-fluorene.

5. The process of claim 3, wherein dissolving metallic lithium in a solution that includes a suitable organic agent, a suitable solvent and a suitable film forming agent comprises forming a solution for dissolving metallic lithium including one or more solvents selected from the following: 1,2-dimethoxyethane, tetrahydrofuran, chloroform, acetonitrile, tetraethylene glycol dimethyl ether dimethylformamide, triethylene glycol dimethyl ether, dimethoxyethane, and 2-methyl-tetrahydrofuran.

6. The process of claim 3, wherein dissolving metallic lithium in a solution that includes a suitable organic agent, a suitable solvent and a suitable film forming agent comprises forming a solution for dissolving metallic lithium including one or more film forming agents selected from the following: fluoroethylene carbonate, vinylene carbonate, 1,1,2,2-tetrafluoroethyl-2,2,3,3-tetrafluoroproppyl ether, bis(2,2,2-trifluoroethyl) ether, 1,1,2,2-tetrafluoroethyl-2,2,2-trifluoroethyl ether, methoxynonafluorobutane, ethoxynonafluorobutane, tris(2,2,2-trifluoroethyl)orthoformate, pentafluoroethyl 2,2,2-trifluoroethyl ether, 2,2,3,3,4,4,5,5-ocatafluoro-1-pentanol, and 2,2,2-trifluoroethyl nonafluorobutanessulfonate.

7. The process of claim 3, wherein forming a liquid lithium composition by dissolving metallic lithium in a solution that includes a suitable organic agent, a suitable solvent and a suitable film forming agent comprises forming a liquid lithium composition having
a lithium source: organic agent molar ratio of from 1:1 to 10:1,
an organic agent concentration in solvent range from 0.1M to 4M, and
a film forming additive weight fraction ranging from 0-5 wt. %.

8. The process of claim 1, wherein dispensing the liquid alkali metal solution on a silicon substrate comprises dispensing on a substrate comprising one or more of silicon, graphite, tin, antimony, hard carbon, phosphorus, aluminum, germanium, sulfur, iron fluoride, iron sulfide, copper fluoride, and AₓMO₂ (0<X<1, A=alkali metals and M=transition metals).

9. The process of claim 1, wherein dispensing the liquid alkali metal solution on a silicon substrate comprises spraying the liquid alkali metal solution on the silicon substrate.

10. The process of claim 10, wherein spraying the liquid alkali metal solution on the silicon substrate comprises using an automated spray gun to spray the liquid alkali metal solution on the silicon substrate in a roll-to-roll processing line.

11. The process of claim 2, wherein dissolving a metallic alkali metal comprises dissolving metallic sodium or metallic potassium to form a liquid sodium or potassium composition and the pre-alkali metal treatment reaction comprises presodiation or prepotassiation.

12. A process for pretreating a silicon substrate with an alkali metal solution, the process comprising:
creating a precursor solution comprising the suitable organic agent, the suitable solvent, and the suitable film forming agent; and
dissolving a metallic alkali metal into the precursor solution to form a liquid alkali metal composition;
dispensing the liquid alkali metal composition on a silicon substrate to initiate an alloying reaction between the silicon substrate and the dissolved alkali metal; and
providing sufficient time for the alloying reaction to proceed.

13. The process of claim 12, further comprising:
forming an ion conductive interphase film from the liquid alkali metal composition on the silicon substrate surface; and
drying residual organic agents and solvents on the treated silicon substrate.

14. The process of claim 12, wherein dissolving the metallic alkali metal comprises dissolving metallic lithium.

15. The process of claim 14, wherein creating a precursor solution comprises forming a solution for dissolving metallic lithium including one or more organic agents selected from the following: naphthalene, biphenyl, 3,3′-dimethylbiphenyle, 4,4′-dimethyl biphenyl, 2-methylbiphenyl, 3,3,4,4′-tetramethylbiphenyl, and 9,9-dimethyl-9H-fluorene.

16. The process of claim 14, wherein creating a precursor solution comprises forming a solution for dissolving metallic lithium including one or more solvents selected from the following: 1,2-dimethoxyethane, tetrahydrofuran, chloroform, acetonitrile, tetraethylene glycol dimethyl ether dimethylformamide, triethylene glycol dimethyl ether, dimethoxyethane, Methyltetrahydrofuran and 2-methy-tetrahydrofuran.

17. The process of claim 14, wherein creating a precursor solution comprises forming a solution for dissolving metallic lithium including one or more film forming agents selected from the following: fluoroethylene carbonate, vinylene carbonate, 1,1,2,2-tetrafluoroethyl-2,2,3,3-tetrafluoroproppyl ether, bis(2,2,2-trifluoroethyl) ether, 1,1,2,2-tetrafluoroethyl-2,2,2-trifluoroethyl ether, methoxynonafluorobutane, ethoxynonafluorobutane, tris(2,2,2-trifluoroethyl)orthoformate, pentafluoroethyl 2,2,2-trifluoroethyl ether, 2,2,3,3,4,4,5,5-ocatafluoro-1-pentanol, and 2,2,2-trifluoroethyl nonafluorobutanessulfonate.

18. The process of claim 14, wherein dissolving a metallic alkali metal into the precursor solution to form a liquid alkali metal composition comprises forming a liquid lithium composition having a lithium source: organic agent molar ratio of from 1:1 to 10:1.

19. The process of claim 14, wherein dissolving a metallic alkali metal into the precursor solution to form a liquid alkali metal composition comprises dissolving the metallic lithium in a precursor where the organic agent's concentration in solvent ranges from 0.1M to 4M and the film forming additive weight fraction ranges from 0-5 wt. %.

20. The process of claim 12, wherein dispensing the liquid alkali metal solution on a silicon substrate comprises dispensing on a substrate comprising one or more of silicon, graphite, tin, antimony, hard carbon, phosphorus, aluminum, germanium, sulfur, iron fluoride, iron sulfide, copper fluoride, and AₓMO₂ (0<X<1, A=alkali metals and M=transition metals).
